(19) United States
(12) Patent Application Publication
(10) Pub. No.: US 2015/0167802 A1
(43) Pub. Date: Jun. 18, 2015

(54) POWER TRANSMISSION UNIT FOR VEHICLE

(71) Applicants: Michio Yoshida, Susono-shi (JP); Hirofumi Nakada, Toyota-shi (JP); Daisuke Kobayashi, Mishima-shi (JP); Hirotsugu Yoshino, Susono-shi (JP)

(72) Inventors: Michio Yoshida, Susono-shi (JP); Hirofumi Nakada, Toyota-shi (JP); Daisuke Kobayashi, Mishima-shi (JP); Hirotsugu Yoshino, Susono-shi (JP)

(73) Assignee: TOYOTA JIDOSHA KABUSHIKI KAISHA, Toyota-shi (JP)

(21) Appl. No.: 14/402,412

(22) PCT Filed: May 23, 2012
(86) PCT No.: PCT/JP2012/063171

§ 371 Date: Jan. 30, 2015

(51) Int. Cl. F16H 37/02

(52) U.S. Cl. CPC F16H 37/021; F16H 2037/026; F16H 2200/0008; F16H 2200/2005; F16H 2200/2035

(57) ABSTRACT

A power transmission unit for a vehicle is provided. In the power transmission unit, torque is transmitted between an input shaft and an output shaft through a continuously variable transmission and a gear train having an intermediate shaft. The continuously variable transmission adapted to alter a speed ratio continuously is disposed between the input shaft to which a torque of a prime mover is inputted and the output shaft that outputs the torque. The gear train is adapted to establish a speed ratio that cannot be established by the continuously variable transmission, and arranged at a different site from positions of the input shaft and the output shaft. The power transmission unit comprises: a torque reversing device that is adapted to perform a differential action among an input element, an output element and a reaction element adapted to rotate the input element and the output element in opposite directions when rotation thereof is halted, and that is disposed coaxially with the output shaft or the intermediate shaft; a first clutch device that connects at least any of two rotary elements of the torque reversing device; and a brake device that halts rotation of the reaction element. The input shaft is connected with the output shaft through the continuously variable transmission, and a second clutch device is disposed on a torque transmitting route from the input shaft to the output shaft via the continuously variable transmission to allow and interrupt torque transmission therethrough. The input shaft is connected with the output shaft through the gear train and the torque reversing device.

### TECHNICAL FIELD

The present invention relates generally to a transmission unit for transmitting power of a prime mover of an automobile, and more particularly, to a power transmission unit comprising a transmission route including a continuously variable transmission, and another transmission route arranged parallel to said transmission route.

### BACKGROUND ART

Generally, an output torque of an internal combustion engine is increased with an increase in a rotational speed, but a vehicle requires a large drive force at low speed and small drive force at high speed. That is, the vehicle required opposite torque characteristic to that generated by the engine. In addition, optimum operating points of the engine are limited. Therefore, the vehicle having the engine as a prime mover is provided with a transmission to alter a speed ratio according to need so that the engine is allowed to be operated at the optimum operating points to generate drive force by altering the speed ratio of the transmission based on a running condition such as a vehicle speed, an accelerator opening etc. However, if a geared transmission adapted to shift a gear stage stepwise is used in the vehicle, the engine cannot be always operated at optimum operating points. That is, if the optimum operating speed exists between the gear stages, the operating efficiency of the engine would be worsened. In order to avoid such disadvantage, a continuously variable transmission has been used in place of the geared transmission.

A belt-driven continuously variable transmission and a toroidal continuously variable transmission are commonly used in vehicles. The belt driven continuously variable transmission is comprised of a belt for transmitting power a pair of pulleys and a belt running on those pulleys to transmit power therebetween. A speed ratio of between those pulleys is altered continuously by changing a groove width of the pulleys to vary a running radius of the belt. In turn, the toroidal continuously variable transmission is comprised of a pair of discs being opposed to each other, and a power roller interposed between those discs. Rotational speeds of those discs are differentiated depending on an inclination of a line connecting contact points between the power roller and each discs with respect to a rotational center of the power roller. That is, speed difference between the disc, i.e., a speed ratio is changed from “1” with an increment in the inclined angle (or tilting angle) of the power roller.

The continuously variable transmission of those kinds are adapted to transmit torque utilizing a friction between the pulley and the belt or a friction between the disc and the power roller so that a speed ratio thereof can be altered continuously. Since the friction is a product of a friction coefficient and a vertical load (or a loading in a normal direction) at the contact points of two members, the larger vertical load is required with an increase in the torque to be transmitted. Specifically, in the belt driven continuously variable transmission of vehicle, the vertical load is a load of the pulley to clamp the belt. To this end, the required load is established by delivering hydraulic fluid to a hydraulic actuator integrated with the pulley.

A large drive force is required to launch the vehicle, but a required drive force to cruise the vehicle is smaller than that to launch the vehicle. That is, the larger vertical load is required to establish the friction to launch the vehicle. Specifically, in the belt-driven continuously variable transmission, higher hydraulic pressure to clamp the belt is required when launching the vehicle. In order to launch the vehicle promptly, an additional hydraulic device for establishing larger hydraulic pressure is required. Consequently, the larger drive system and the hydraulic system will be enlarged by such additional hydraulic device. In addition, fuel economy will be worsened as a result of establishing high pressure.

Japanese Patent Laid-Opens Nos. 2005-308041, 2004-076876, and 2000-130548 describe systems for dealing with the foregoing disadvantages. According to the teachings of Japanese Patent Laid-Open No. 2005-308041, an engine power is applied to a sun gear of a single-pinion planetary gear unit serving as a torque reversing device, and the sun gear is connected to an input shaft integrated with a primary pulley of a belt-driven continuously variable transmission through a clutch. An input gear is fitted onto the input shaft through a one-way clutch, and the input gear is connected with a ring gear of torque reversing device. The one-way clutch is adapted to be engaged when the input shaft rotates in a forward direction at higher speed than the input gear situated at the outer circumferential side. An output gear is fitted onto an output shaft integrated with a secondary pulley through another one-way clutch, and an idle gear is disposed between the output gear and the input gear while being meshed therewith. That is, the input gear and the output gear are rotated together in the same direction. A gear ratio (or speed ratio) between the input gear and the output gear is slightly smaller than the maximum speed ratio of the continuously variable transmission comprised of those pulleys and the belt wrapped around those pulleys. Said another one-way clutch is adapted to be engaged when the output shaft rotates in the forward direction at higher speed than the output gear. In addition, a friction clutch is arranged in parallel with said one-way clutch. Further, a brake to fix a carrier of the torque reversing device is arranged to drive the vehicle in the backward direction.

Thus, in the power transmission device taught by Japanese Patent Laid-Open No. 2005-308041, the vehicle is launched in the forward direction by connecting the sun gear with the input shaft by the clutch to transmit the torque to main speed change route comprised of the continuously variable transmission the through the input shaft, and by engaging the one-way clutch to further transmit the torque to a sub speed change route. In this situation, since the speed ratio of the gear train is slightly smaller than the maximum speed ratio of the continuously variable transmission, the output gear rotates at higher speed than the output shaft. Consequently, the one-way clutch at the output shaft side is brought into disengagement so that the torque is transmitted to the drive wheels through the gear train. Therefore, the large torque will not be applied to the continuously variable transmission when launching the vehicle. After launching the vehicle, the speed ratio of the continuously variable transmission is gradually reduced with an increase in the vehicle speed so that a rotational speed of the output shaft integrated with the secondary pulley is raised to that of the output gear situated outer circumferential side of the output shaft, and then further raised with a decrease in the speed ratio. As a result, the one-way clutch of output shaft side is brought into engagement so that the torque is transmitted to the drive wheels through the continuously variable transmission. In this situation, the one-way clutch of the input shaft side is in disengagement, therefore an interlock will not occur.

Japanese Patent Laid-Open No. 2004-076876 describes a power transmission device in which a torque reversing device comprised of a single pinion planetary gear unit is disposed between an input shaft transmitting power from an engine and a primary pulley of a belt-driven continuously variable transmission. A ring gear of the torque reversing device is connected with the primary pulley to be rotated therewith, and a sun gear is connected with an input shaft. Therefore, a forward stage is achieves by connecting the sun gear with the ring gear by a clutch, and a reverse stage is achieved by fixing a carrier by a brake. In addition, a gear train adapted to establish a speed ratio a larger than a maximum speed ratio of a continuously variable transmission is formed between the input shaft and the output shaft integrated with a secondary pulley. An input gear of the gear train is integrated with the input shaft, and an output gear connected with the input shaft through an idle gear is fitted onto the output shaft while being allowed to rotate. In addition, a one-way clutch and a friction clutch are arranged in series between the output gear and the output shaft.

Accordingly, when launching the vehicle in the forward direction, the clutch for connecting the input shaft with the primary pulley is disengaged while engaging the clutch of the output shaft side, thereby transmitting torque to the output shaft from the input shaft through the gear train, the one-way clutch, and the clutch arranged in series therewith. The maximum speed ratio of the continuously variable transmission is slightly smaller than that of the gear train. In this situation, therefore, the secondary pulley and the output shaft integrated therewith are rotated at a speed higher than the previous speed and a rotational speed of output gear so that the one-way clutch is brought into disengagement. Consequently, the torque is transmitted to the output shaft through the continuously variable transmission. Since the gear train thus transmits the torque when launching the vehicle, a large torque is not applied to the continuously variable transmission when launching the vehicle.

Japanese Patent Laid-Open No. 2000-130548 describes a transmission similar to that taught by Japanese Patent Laid-Open No. 2004-076876. That, is, is the transmission taught by Japanese Patent Laid-Open No. 2000-130548, the one-way clutch and the friction clutch are arranged parallel to each other between the output gear of the gear train that transmits torque when launching a vehicle and an output shaft integrated with the secondary pulley.

Thus, in any of the teachings of those prior art documents, the gear train is arranged in parallel with the belt-driven continuously variable transmission, and the torque for launching the vehicle is transmitted through the gear train. According to those prior art documents, in order to propel the vehicle in the forward direction, the torque transmission route is switched by the one-way clutch to transmit torque through the continuously variable transmission. However, although both forward and reverse torques are required to propel the vehicle, a torque transmitting direction of the one-way clutch is limited to one direction. In addition, the one-way clutch may not be required depending of a structure of the torque transmission route. According to the teachings of the aforementioned prior art documents, therefore, both the one-way clutch and the friction clutch are required. Thus, although a large torque will not be applied to the continuously variable transmission when launching the vehicle, the power transmission systems taught by the prior art documents are rather large and it is not be fit in the vehicle easily.

Both of the systems taught by Japanese Patent Laid-Open Nos. 2005-308041 and 2004-076876 are provided with the torque reversing device composed of a planetary gear mechanism. According to the teachings of Japanese Patent Laid-Open No. 2005-308041, when the vehicle is propelled by transmitting torque through the belt-driven continuously variable transmission, the engine torque is transmitted to the sun gear and the torque of the gear train is transmitted to the ring gear. That is, the sun gear, the pinion gear, and the ring gear are rotated at speeds significantly different among each other. Consequently, a power loss, deterioration of lubricant, noises or vibrations etc. may be caused. According to the teachings of Japanese Patent Laid-Open No. 2004-076876, when the vehicle is propelled by transmitting torque through the gear train, the engine torque is transmitted to the sun gear of the planetary gear mechanism and the torque of the output shaft side is transmitted to the ring gear though the continuously variable transmission. Consequently, as the transmission taught by Japanese Patent Laid-Open No. 2005-308041, the sun gear, the pinion gear, and the ring gear are rotated at speeds significantly different among each other, and this may cause a power loss, deterioration of lubricant, noises or vibrations etc.

### DISCLOSURE OF THE INVENTION

The present invention has been conceived noting the foregoing technical problem, and it is therefore an object of the present invention is to provide a power transmission unit for a vehicle having a continuously variable transmission, more particularly, to a power transmission unit that is adapted to establish a speed ratio larger than a maximum speed ratio of the continuously variable transmission or a speed ratio smaller than a minimum speed ratio of the continuously variable transmission, that can be downsized easily, and that is excellent in durability.

The present invention is applied to a power transmission unit for a vehicle comprised of: a continuously variable transmission that is adapted to alter a speed ratio continuously, and that is disposed between an input shaft to which a torque of a prime mover is inputted and an output shaft that outputs the torque; and a gear train that has an intermediate shaft arranged at a different site from positions of the input shaft and the output shaft, and that is adapted to establish a speed ratio that cannot be established by the continuously variable transmission. In the vehicle, accordingly, the torque is transmitted between the input shaft and the output shaft through the continuously variable transmission and the gear train. In order to achieve the above-explained objectives, according to the present invention, the power transmission unit is provided with a torque reversing device that is adapted to perform a differential action among an input element, an output element and a reaction element adapted to rotate the input element and the output element in opposite directions when rotation thereof is halted, and that is disposed coaxially with the output shaft or the intermediate shaft; a first clutch device that connects at least any of two rotary elements of the torque reversing device; and a brake device that halts rotation of the reaction element. In the power transmission unit, the input shaft is connected with the output shaft through the continuously variable transmission, and a second clutch device is disposed on a torque transmitting route from the input shaft to the output shaft via the continuously variable transmission to allow and interrupt torque transmission therethrough. In addition, the input shaft is connected with the output shaft through the gear train and the torque reversing device.

The gear train is adapted to establish a speed ratio larger than a maximum speed ratio of the continuously variable transmission or a speed ratio smaller than a minimum speed ratio of the continuously variable transmission using a plurality of gears.

The continuously variable transmission is comprised of a drive member to which the torque is transmitted from the input shaft, and an output member that outputs the torque to the output shaft. The second clutch device may be disposed between the input shaft and the drive member to selectively connect the input shaft to the drive member.

As described, the continuously variable transmission is comprised of a drive member to which the torque is transmitted from the input shaft, and an output member that outputs the torque to the output shaft. The second clutch device may also be disposed between the output member and the output shaft to selectively connect the output shaft to the output shaft.

For example, a fiction clutch may be used as the first clutch device and the second clutch device.

The gear train is comprised of: a drive gear disposed coaxially with the input shaft; an idle gear disposed on the intermediate shaft or plurality of idle gears rotated integrally; and a driven gear to which the torque is transmitted from the drive gear through the idle gear, and that is connected to the input element. In addition, the gear train is adapted to establish a speed ratio larger than 1 in case of transmitting the torque from the drive gear to the input element through the idle gear and the driven gear.

Alternatively, the gear train may also be comprised of: a drive gear disposed coaxially with the input shaft; a driven gear disposed coaxially with the output shaft; a first idle gear disposed coaxially with the intermediate shaft to transmit the torque between the drive gear and the input element; and a second idle gear disposed coaxially with the intermediate shaft to transmit the torque between the output element and the drive gear. In this case, the gear train establishes a speed ratio larger than 1 at least in any of: a case of transmitting the torque from the drive gear to the input element through the first idle gear; and a case of transmitting the torque from the driven gear to the output element through the second idle gear.

For example, a double-pinion planetary gear unit may be used as the torque reversing device. In this case, the torque reversing device is comprised of: a sun gear as an external gear; a ring gear as an internal gear arranged concentrically with the sun gear; a first pinion gear meshing with the sun gear; a second pinion gear meshing with the first pinion gear and the ring gear; and a carrier supporting the first pinion gear and the second pinion gear while allowing to rotate and revolve.

Given that the double-pinion planetary gear unit is used as the torque reversing device, the sun gear is connected to the continuously variable transmission and the output shaft the carrier is connected to the gear train, and rotation of the ring gear is halted by the brake device.

Given that the double-pinion planetary gear unit is used as the torque reversing device, the sun gear may also be connected to the intermediate shaft and the first idle gear, the carrier may also be connected to the second idle gear, and rotation of the ring gear may also be halted by the brake device.

Instead, given that the double-pinion planetary gear unit is used as the torque reversing device, the sun gear may also be connected to the intermediate shaft and the second idle gear, the carrier may also be connected to the first idle gear, and rotation of the ring gear may also be halted by the brake device.

Alternatively, a single-pinion planetary gear unit may also be used as the torque reversing device. In this case, the torque reversing device is comprised of: a sun gear as an external gear; a ring gear as an internal gear arranged concentrically with the sun gear; a pinion gear meshing with the sun gear and the ring gear; and a carrier supporting the pinion gear while allowing to rotate and revolve.

Given that the single-pinion planetary gear unit is used as the torque reversing device, the ring gear is connected to the continuously variable transmission and the output shaft, the sun gear is connected to the gear train, and rotation of the carrier is halted by the brake device.

Given that the single-pinion planetary gear unit is used as the torque reversing device, the ring gear may also be connected to the intermediate shaft and the first idle gear, the sun gear may also be connected to the second idle gear, and rotation of the carrier may also be halted by the brake device.

Instead, given that the single-pinion planetary gear unit is used as the torque reversing device, the ring gear may also be connected to the intermediate shaft and the second idle gear, the sun gear may also be connected to the first idle gear, and rotation of the carrier may also be halted by the brake device.

The rotary elements of the planetary gear unit serving as the torque reversing device such as the input element, the output element and the reaction element are indicated in a nomographic diagram by lines parallel to one another. In the nomographic diagram, specifically, rotational speeds of those rotary elements are indicated individually by a distance between each line and an intersection with a base line and a position with respect to the base line. In the nomographic diagram, the reaction element is represented by the line situated in the middle of those lines, the input element is represented by the line situated in any of right and left sides, and the reaction element is represented by the line situated on the other side.

Thus, according to the present invention, the torque reversing device is rotated integrally by connecting at least two rotary elements thereof by the first clutch device so that the gear train is enabled to transmit power between the input shaft and the output shaft through the torque reversing device. In this situation, the continuously variable transmission is disconnected form the input shaft or the output shaft, and the gear train is connected with the output shaft by disengaging the second clutch device. That is, the input shaft is connected with the output shaft through the gear train and the torque reversing device. Consequently, a speed ratio that cannot be established by the continuously variable transmission is achieved by the gear train. Specifically, the speed ratio larger than the maximum speed ratio of the continuously variable transmission or smaller than the minimum speed ratio of the continuously variable transmission is established by the gear train. Therefore, a range of a total speed ratio of the power transmission unit can be widened wider than that of the continuously variable transmission.

Rotation of the reaction element of the torque reversing device can be halted by engaging the brake device instead of the first clutch device. Consequently, the output element of the torque reversing device is rotated in the direction opposite to the input element, that is, the vehicle is propelled in the backward direction. In this situation, the torque is transmitted from the output element to the output shaft through the gear train and the torque reversing device. As a result, the power transmission unit is allowed to establish the speed ratio which cannot be achieved by the continuously variable transmission.

When decelerating the vehicle, torque is inputted from the output shaft side. However, the torque inputted from the output shaft to the continuously variable transmission can be cut off to protect the continuously variable transmission by arranging the second clutch device between the driven member of the continuously variable transmission and the output shaft, and by bringing the second clutch device into disengagement.

If he first clutch device is disengaged under the condition where the speed ratio of the continuously variable transmission is approximated to the speed ratio of the gear train while engaging the second clutch device, the input shaft is connected with the output shaft through the second clutch device and the continuously variable transmission, and the gear train is disconnected from the input shaft. That is, the torque reversing device is disabled to transmit the torque to any of the rotary elements so that the torque transmission between the input shaft and the output shaft through the torque reversing device is interrupted. Consequently, the continuously variable transmission is allowed to alter the speed ratio thereof arbitrarily. To this end, if the friction clutch whose torque capacity can be altered gradually is used as the first and the second clutch devices, the torque of the output shaft may be changed smoothly by gradually changing the torque capacities of the first and the second clutch devices. Consequently, shift shocks and uncomfortable feeling resulting from a change in the drive force can be reduced.

Thus, the gear train and the torque reversing device are disconnected from both of the input shaft and the output shaft by engaging the second clutch device while disengaging the first clutch device. Therefore, when the torque is transmitted through continuously variable transmission during running, the gear train will not be rotated, and a speed difference among the rotary members will not be widened by the torques delivered from the torque reversing device and the output element. For these reasons, power loss can be reduced, durability of the transmission can be improved, and noises and vibrations can be suppressed.

As described, according to the present invention, the torque reversing device is comprised of the input element, the output element, and the reaction element to serve as a differential. The torque reversing device thus structured is not disposed on the input shaft but on the output shaft or the intermediate shaft. Therefore, a speed difference among the rotary members of the torque reversing device will not be widened in case of transmitting torque from the input shaft to the output shaft through the continuously variable transmission. Given that the torque reversing device is disposed coaxially with the output shaft, the torque can be transmitted from the input shaft to the input element through the gear train while reducing a rotational speed by establishing the speed ratio larger than 1 by the gear train. Consequently, the speed difference among the rotary members of the torque reversing device can be reduced. Instead, given that the torque reversing device is disposed coaxially with the intermediate shaft, the speed ratio between the driven gear and the first idle gear or the second idle gear transmitting the torque from the input shaft and the input element of the torque reversing device is increased to be larger than 1. Therefore, the torque can be transmitted to the input element or the output element while reducing the rotational speed so that the speed difference among the rotary members of the torque reversing device can be reduced. For these reasons, it is unnecessary to arrange an additional clutch for reducing such speed difference in the torque reversing device which might be caused by transmitting torque to the input element and the output element of the torque reversing device. Consequently, the structure of the power transmission unit can be simplified so that the power transmission unit can be downsized.

As also described, according to the present invention, the friction clutch having a unified structure can be used as the first clutch device, the second clutch device, and the brake device. Therefore, the structure of the power transmission unit can be simplified. In addition, the single-pinion or double pinion planetary gear unit can be used as the torque reversing device. Therefore, a length of the power transmission unit can be shortened so that the power transmission unit is allowed to be fit into a vehicle easily.

### BRIEF DESCRIPTION OF THE DRAWINGS

FIG. 1 is a skeleton diagram showing a first example of the power transmission unit for a vehicle according to the present invention.

FIG. 2 is a nomographic diagram (or speed diagram) showing rotational states of each rotary element of the double-pinion planetary gear unit (an arrangement of the output shaft, a carrier input) serving as the torque reversing device.

FIG. 3 is a table showing engagement operating states of clutch devices and the brake device.

FIG. 4 is a skeleton diagram showing a second example of the power transmission unit for a vehicle according to the present invention.

FIG. 5 is a skeleton diagram showing a third example of the power transmission unit for a vehicle according to the present invention.

FIG. 6 is a skeleton diagram showing a fourth example of the power transmission unit for a vehicle according to the present invention.

FIG. 7 is a nomographic diagram (or speed diagram) showing rotational states of each rotary element of the double-pinion planetary gear unit (an arrangement of the intermediate shaft, a sun gear input) serving as the torque reversing device shown in FIGS. 5 and 6.

FIG. 8 is a skeleton diagram showing another example of the power transmission unit for a vehicle according to the present invention.

FIG. 9 is a skeleton diagram showing another example of the power transmission unit for a vehicle according to the present invention.

FIG. 10 is a skeleton diagram showing another example of the power transmission unit for a vehicle according to the present invention.

FIG. 11 is a skeleton diagram showing another example of the power transmission unit for a vehicle according to the present invention.

FIG. 12 is a nomographic diagram (or speed diagram) showing rotational states of each rotary element of the double-pinion planetary gear unit (an arrangement of the intermediate shaft, a carrier input) serving as the torque reversing device shown in FIGS. 10 and 11.

FIG. 13 is a skeleton diagram showing an example of the single-pinion planetary gear unit serving as the torque reversing device.

FIG. 14 is a nomographic diagram (or speed diagram) showing rotational states of each rotary element of the single-pinion planetary gear unit (an arrangement of the output shaft, a sun gear input) serving as the torque reversing device shown in FIGS. 1 and 4.

FIG. 15 is a nomographic diagram (or speed diagram) showing rotational states of each rotary element of the single-pinion planetary gear unit (an arrangement of the intermediate shaft, a ring gear input) serving as the torque reversing device shown in FIGS. 5 and 6.

### DESCRIPTION OF PREFERRED EMBODIMENT(S)

Next, the present invention will be explained with reference to the accompanying drawings. According to the present invention, there is provided a power transmission unit for transmitting a power of a prime mover such as an engine and a motor, and the power transmission unit has a speed change function. In general, this kind of power transmission unit is called a transmission or a transaxle. More specifically, the present invention is applied to a power transmission unit in which a continuously variable transmission and a gear train of predetermined speed ratio (or a gear ratio) are arranged parallel to each other between an input shaft and an output shaft. In the power transmission unit, a conventional belt-driven continuously variable transmission and a toroidal continuously variable transmission may be used. Specifically, the belt-driven continuously variable transmission is suitable for a power transmission unit of an FF layout vehicle (i.e., a front engine/front wheel drive vehicle), and the toroidal continuously variable transmission is suitable for a power transmission unit of an FR layout vehicle (i.e., a front engine/rear wheel drive vehicle). The gear train is formed to transmit a torque from an input shaft to an output shaft, and adapted to establish a speed ratio which cannot be established by the continuously variable transmission according to need. To this end, the gear train is formed by meshing a plurality of gears, and a gear ratio (i.e., a ratio between numbers of tooth) thereof is adjusted to establish a speed ratio larger than a maximum speed ratio of the continuously variable transmission or a speed ratio smaller than a minimum speed ratio of the continuously variable transmission. In order to prevent the continuously variable transmission from being subjected to a large torque for launching the vehicle, it is preferable to form the gear train in a manner to establish a speed ratio larger than a maximum speed ratio of the continuously variable transmission. By contrast, in order to improve a fuel economy by lowering a speed of a prime mover, it is preferable to form the gear train in a manner to establish a speed ratio smaller than a minimum speed ratio of the continuously variable transmission.

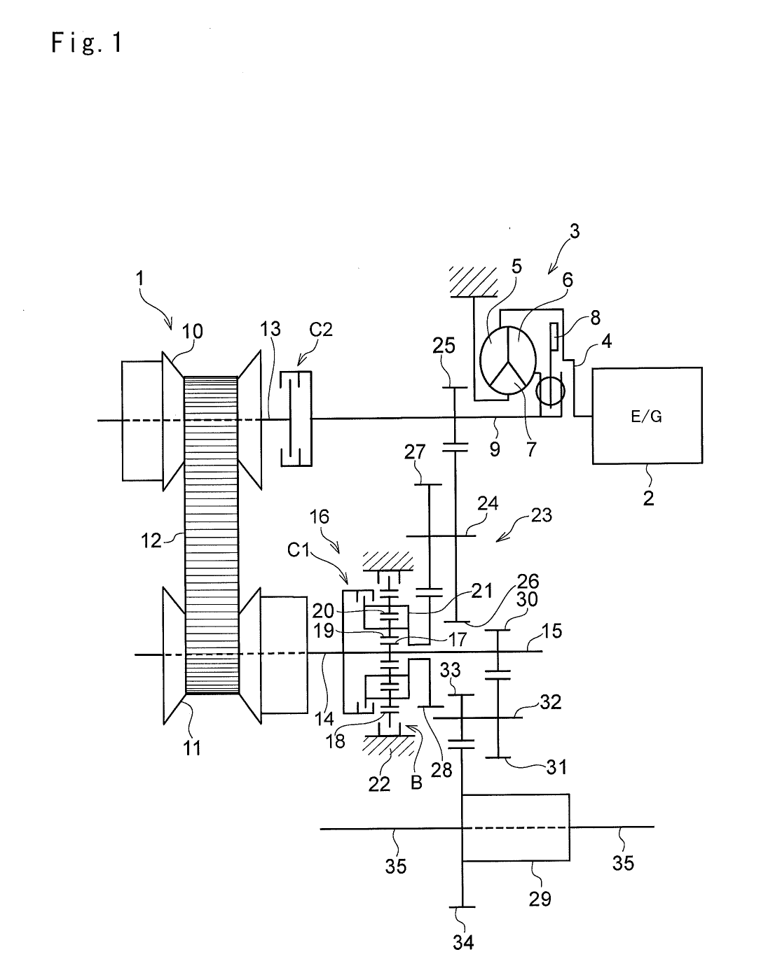

Referring now to FIG. 1, there is shown a first example of the power transmission unit adapted for the FF layout vehicle. Accordingly, a belt-driven continuously variable transmission is employed as a continuously variable transmission 1, and an internal combustion engine such as a gasoline engine is employed as a prime mover (as will be called the “engine” hereinafter, and abbreviated as “E/G” in the drawings) 2.

A conventional torque converter 3 having a lockup clutch 8 is connected to an output shaft (i.e., a crank shaft) of the engine 2. The torque converter 3 is comprised of a pump impeller 5 integrated with a front cover 4, a turbine runner 6 being opposed to the pump impeller 5, and a stator 7 that is held through a not shown one-way clutch and that is interposed between the pump impeller 5 and the turbine runner 6. The lockup clutch 8 is arranged to be opposed to an inner face of the front cover 4 in a manner to be rotated together with the turbine runner 6. Therefore, the lockup clutch 8 is engaged with the inner face of the front cover 4 to transmit torque therebetwen depending on a difference between pressures on both sides of the lockup clutch 8. Such torque transmission between the lockup clutch 8 and the front cover 4 is interrupted by disengaging the lockup clutch 8 from the inner face of the front cover 4. The turbine runner 6 is connected to an input shaft 9.

As known in the prior art, the continuously variable transmission 1 is comprised of the primary pulley 10 as a drive member, a secondary pulley 11 as a driven member, and a belt 12 running on those primary pulley 10 and the secondary pulley 11. Accordingly, a speed ratio of the continuously variable transmission 1 is changed by altering groove widths of the primary pulley 10 and the secondary pulley 11 thereby altering running radii of the belt 12.

The primary pulley 10 is arranged coaxially with the input shaft 9 on an opposite side of the engine 2 across the torque converter 3, and a primary shaft 13 integrated with the primary pulley 10 is connected to the input shaft 9 through the after-mentioned second clutch device C2. On the other hand, the secondary pulley 11 is disposed in a manner to rotate around a rotational axis parallel to a rotational axis of the primary pulley 10, and provided with a secondary shaft 14 extending along with the rotational axis thereof. An output shaft 15 is arranged coaxially and integrally with the secondary shaft 14. Thus, the output shaft 15 is extended parallel to the input shat 9.

In order to selectively connect the input shaft 9 with the primary shaft 13, a second clutch device C2 is disposed between the input shaft 9 and the primary shaft 13. That is, the second clutch device C2 selectively interrupts a torque transmission between the input shaft 9 and the primary shaft 13. To this end, for example, any of a friction clutch and a dog clutch may be used as the second clutch device C2, but a dry type or wet type friction clutch whose torque transmitting capacity is varied according to a change in an engagement force is especially preferable.

In the power transmission unit of the present invention, a torque reversing device 16 is arranged coaxially with the output shaft 15 connected with the secondary shaft 14 of the continuously variable transmission 1. The torque reversing device 16 is adapted to propel the vehicle in the forward direction by the torque transmitted from the input shaft 9 without switching a torque direction, and to propel the vehicle in the backward direction by the torque transmitted from the input shaft 9 while switching a torque direction. Specifically, the torque reversing device 16 is a differential mechanism adapted to perform differential action among three rotary elements. A various kinds of differential mechanisms are known in the art, and any kind of differential mechanism may be used in the present invention. In the example shown in FIG. 1, a double-pinion planetary gear unit is employed as the torque reversing device 16.

The double-pinion type planetary gear unit is comprised of a sun gear 17 as an external gear, a ring gear 18 as an internal gear arranged concentrically with the sun gear 17, a first pinion gar 19 meshed with the sun gear 17, a second pinion gear 20 meshed with the first pinion gear 10 and the ring gear 18, and a carrier 21 supporting the first pinion gear 19 and the second pinion gear 20 while allowing to rotate and revolve. The carrier 21 is connected with the input shaft 9 through an after-mentioned train gear 23 to serve as an input element. In order to selectively stop the rotation of the ring gear 18 serving as a reaction element, a brake device B is disposed between the ring gear 18 and a fixing portion 22 such as a casing. For example, a frictional brake such as a multi-disc brake or a dog brake may be used as the brake device B.

The sun gear 17 is fitted onto the assembly of the secondary shaft 14 of the of the continuously variable transmission 1 and the output shaft 15 to serve as an output element. In order to connect the sun gear 17 with the carrier 21 thereby rotating the planetary gear unit integrally, a first clutch device C1 is disposed between the sun gear 17 and the carrier 21. Specifically, the first clutch device C1 is used to propel the vehicle in the forward direction, therefore, the first clutch device C1 may also be called a “forward clutch”. For example, any of a friction clutch and a dog clutch adapted to interrupt torque transmission may be used as the first clutch device C1, but a dry type or wet type friction clutch whose torque transmitting capacity is varied according to a change in an engagement force is especially preferable.

More specifically, the first clutch device C1 is adapted to integrate the planetary gear unit serving as the torque reversing device 16 by connecting at least two rotary elements out of three rotary elements. Instead of thus connecting the sun gear 17 with the carrier 21 as the example shown in FIG. 1, the planetary gear unit may also be integrated by connecting the sun gear with the ring gear by the “forward clutch” described in Japanese Patent Laid-Open No. 2010-276159 or 2010-216613. Alternatively, the planetary gear unit may also be integrated by connecting the carrier with the ring gear by the “forward clutch” described in Japanese Patent Laid-Open No. 2005-337360. Further, the planetary gear unit may also be integrated by connecting all of three rotary elements.

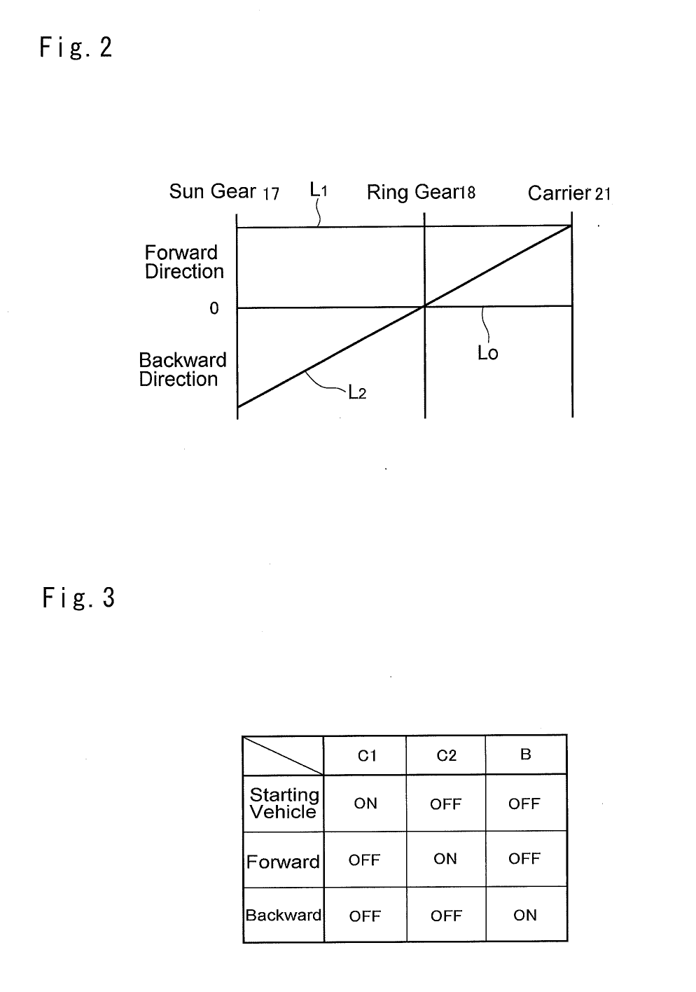

Referring now to FIG. 2, there is shown a nomographic diagram (or speed diagram) indicating the planetary gear unit serving as the torque reversing device 16. In FIG. 2, vertical lines parallel to one another individually represent the sun gear 17, the ring gear 18, and the carrier 21. Specifically, the line representing the sun gear 17 is situated in the left side, the line representing the carrier 21 is situated in the right side, and the line representing the ring gear 18 as the reaction element is situated in the middle. Given that an interval between the line representing the sun gear 17 and the line representing the carrier 21 is set to “1”, an interval between the line representing the sun gear 17 and the line representing the ring gear 18 is set to a value corresponding to a ratio between tooth number of the carrier 21 and tooth number of the ring gear 18 (i.e., a gear ratio). In FIG. 2, a distance between each vertical line and an intersection with a base line L0 represents a rotational speed of the rotary element, and a vertical position with respect to the base line L0 represents a rotational direction of the rotary element. As described, the torque reversing device 16 is rotated integrally by bringing the first clutch C1 into engagement. In this case, therefore, the rotational speeds of those rotary elements are indicated as a line L1. Given that the ring gear 18 is halted by the brake device B, the rotational speeds of those rotary elements are indicated as a line L2. That is, the sun gear 17 is rotated in a direction opposite to the rotational direction of the carrier 21.

In the power transmission unit of the present invention, a gear train 23 comprised of a plurality of parallel gears is formed parallel to the continuously variable transmission 1. The gear train 23 is adapted to serve as a speed reducing mechanism for establishing a speed ratio larger than the maximum speed ratio of the continuously variable transmission 1, or to serve as a speed increasing mechanism for establishing a speed ratio smaller than the minimum speed ratio of the continuously variable transmission 1. According to the example shown in FIG. 1, specifically, the gear train 23 serves as the speed reducing mechanism for the case of transmitting torque from the input shaft 9 to the output shaft 15. To this end, the gear train 23 is comprised of a drive gear fitted onto the input shaft 9, an idle gear adapted to rotate the input shaft 9 and the output shaft 15 in the same direction, and a driven gear to which torque of the drive gear is delivered through the idle gear.

Specifically, a counter shaft 24 serving as the intermediate shaft of the invention is arranged parallel to the input shaft 9 and the output shaft 15, and a drive gear 25 is fitted onto the input shaft 9 while being allowed to rotate relatively therewith. A counter driven gear 26 is fitted onto the counter shaft 24 to be meshed with the drive gear 25, and a counter drive gear 27 diametrically smaller than the counter driven gear 26 is also fitted onto the counter shaft 24. A driven gear 28 meshed with the counter drive gear 27 is connected with the carrier 21. Accordingly, the counter driven gear 26 and the counter drive gear 27 serve as the idle gear of the invention.

The counter driven gear 26 is diametrically larger than the drive gear 25 so that the rotational speed of the counter driven gear 26 is reduced when transmitting torque from the drive gear 25 to the counter driven gear 26. That is, the speed ratio (i.e., a gear ratio) of the gear train 23 can be calculated by multiplying the speed ratio between the drive gear 25 and the counter driven gear 26 by the speed ratio between the counter drive gear 27 and the driven gear 28. According to the example shown in FIG. 1, the speed ratio of the gear train 23 of the case of transmitting torque from the drive gear 25 to the carrier 21 of the torque reversing device 16 through the counter driven gear 26 and the counter drive gear 27 is larger than “1”, and this is larger than the maximum speed ratio of the continuously variable transmission 1.

In order to be adapted for the FF layout vehicle, according to the example shown in FIG. 1, the torque of the output shaft 15 is delivered to a front differential 29 serving as a final reduction unit. Specifically, an output gear 30 is fitted onto the output shaft 15, and a large gear 31 is fitted onto a speed reduction gear shaft 32 to be meshed with the output gear 30. A small gear 33 is also fitted onto the speed reduction gear shaft 32 to be meshed with a ring gear 34 of the front differential 29. The torque transmitted to the front differential 29 through the ring gear 34 is further transmitted to the not shown drive wheels through each drive shaft 35.

In the power transmission unit of the present invention, when launching the vehicle in any of the forward and the backward direction, the torque of the input shaft 9 is transmitted to the output shaft 9 through the torque transmission route having the gear train 23. Then, when the speed of the vehicle running in the forward direction is increased to a certain extent, the torque of the input shaft 9 is transmitted to the output shaft 9 through the torque transmission route having the continuously variable transmission 1. For example, if a drive position (or a drive range) is selected by a not shown shifting device, the first clutch device C1 is engaged and the second clutch device C2 and the brake device B are disengaged. The engagement states of those engagement elements are shown in FIG. 3. In FIG. 3, “ON” represents an engagement of the engagement element, and “OFF” represents a disengagement of the engagement element.

When launching the vehicle in the forward direction, specifically, engagement states of those engagement devices are controlled as shown in FIG. 3. Consequently, the torque of the engine 2 is delivered to the input shaft 15 through the input shaft 9, the gear train 23, and the torque reversing device 16. As described, the drive gear 25 of the gear train 23 is fitted onto the input shaft 9 so that the torque of the input shaft 9 is transmitted from the driven gear 28 of the gear train 23 to the carrier 21 of the torque reversing device 16. In this situation, the torque is also transmitted to the sun gear 17 through the first clutch device C1. When propelling the vehicle in the forward direction, in the torque reversing device 16, the sun gear 17 is connected to the carrier 21 by the first clutch device C1 so that the torque reversing device 16 is rotated integrally. In this situation, therefore, the torque of the carrier 21 is transmitted to the output shaft 15 through the sun gear 17 without increasing the speed.

The torque thus transmitted to the output shaft 15 is further transmitted from the output gear 30 to the drive wheels through the speed reducing gear train and the front differential 29. Consequently, the vehicle is launched. In the example shown in FIG. 1, the continuously variable transmission 1 is always connected to the output shaft 15 or the sun gear 17 so that the torque delivered to the torque reversing device 16 is also transmitted to the secondary pulley 11 of the continuously variable transmission 1. However, when launching the vehicle, the second clutch device C2 is in disengagement to interrupt torque transmission between the continuously variable transmission 1 and the output shaft 15. For this reason, an interlock will not occur.

Thus, when launching the vehicle, the torque of the input shaft 9 is transmitted to the output shaft 15 through the gear train 23. According to this example, the gear train 23 serves as the speed reducing mechanism for increasing the speed ratio between the input shaft 9 and the output shaft 15 to be larger than the maximum speed ratio of the continuously variable transmission 1 to generate large drive force to launch the vehicle. In this situation a large torque for launching the vehicle will not be applied to the continuously variable transmission 1, therefore, it is unnecessary to increase hydraulic pressure governing the torque transmitting capacity. For this reason, the power will not be consumed to establish high pressure so that fuel economy can be improved. In addition, damage to the continuously variable transmission can be reduced.

When the vehicle speed is increased to the predetermined speed after launching the vehicle, the speed ratio of the continuously variable transmission 1 is increased to the ratio close to the maximum ratio. In this situation, the first clutch device C1 is brought into disengagement and the second clutch device C2 is brought into engagement. Since the first clutch device C1 is thus disengaged while disengaging the brake device B, the torque reversing device 16 is allowed to rotate freely. Consequently, the output shaft 15 is disconnected from the gear train 23, and the primary pulley 10 is connected with the input shaft 9 by the second clutch device C2. As a result, the input shaft 9 is connected with the output shaft 15 through the continuously variable transmission 1 to transmit torque therebetween. According to this example, therefore, speed of the engine 2 can be adjusted in an optimally fuel efficient manner by gradually altering or reducing the speed ratio of the continuously variable transmission 1 according to the vehicle speed and the opening degree of the accelerator.

As described, the speed ratio of the gear train 23 is larger than the maximum speed ratio of the continuously variable transmission 1. Therefore, if the torque transmitting route is shifted from the route via the gear train 23 to the route via the continuously variable transmission 1, the speed ratio or the drive force will be changed significantly. In this case, the first clutch device C1 is engaged and the second clutch device is disengaged while causing a slip. Specifically, an engagement pressure of the second clutch device C2 is increased gradually thereby increasing the torque transmitting capacity thereof gradually, while reducing an engagement pressure of the first clutch device C1 thereby reducing the torque transmitting capacity thereof gradually. That is, a conventional clutch-to-clutch shifting is carried out to change the torque of the output shaft 15 smoothly thereby reducing shift shocks and uncomfortable feeling.

After the first clutch device C1 is disengaged completely and the second clutch device C2 is engaged completely, the torque of the input shaft 9 is transmitted to the carrier 21 of the torque reversing device 16, and the torque of the secondary pulley 11 is transmitted to the sun gear 17. In this situation, since the ring gear 18 and the carrier 21 are allowed to rotate freely, the rotary elements of the torque reversing device are rotated at different speeds. However, as described, the speed ratio of the gear train 23 of the case of transmitting torque from the drive gear 25 to the carrier 21 of the torque reversing device 16 through the idle gear and the driven gear 28 is larger than “1”. Therefore, the speed difference among the rotary members of the torque reversing device 16 is reduced. For this reason, when transmitting torque from the input shaft 9 to the output shaft 15 through the continuously variable transmission 1, a power loss, deterioration in durability, noises or vibrations etc. resulting from such speed difference among the rotary members of the torque reversing device 16 can be prevented.

In order to propel the vehicle in the backward direction, as shown in FIG. 3, the first clutch device C1 and the second clutch device C2 are brought into disengagement, and the brake B is brought into engagement. In this case, in the torque reversing device 16, the torque of the engine 2 is applied to the carrier 21 through the gear train 23 while fixing the ring gear 18 by the brake device B. Consequently, the sun gear 17 is rotated in the direction opposite to the rotational direction of the carrier 21 so that the torque is transmitted from the input shaft 9 to the output shaft 15 through the gear train 23 as the case of launching the vehicle in the forward direction. In this case, the output shaft 15 is rotated in the direction to propel the vehicle backwardly, and the speed ratio of the gear train 23 is multiplied by the speed ratio of the planetary gear unit serving as the torque reversing device 16. The torque is further transmitted from the output gear 30 to the drive wheels through the speed reducing gear train and the front differential 29 to propel the vehicle in the backward direction. In this situation, since the second clutch device C2 is in disengagement, the torque will not be transmitted between the continuously variable transmission 1 and the input shaft 9. That is, a torque will not be transmitted from the input shaft 9 to the output shaft 15 through the continuously variable transmission 1. For this reason, an interlock will not occur.

Thus, according to the power transmission unit of the present invention, the speed ratio that cannot be established by the continuously variable transmission 1 can be achieved when launching the vehicle in either forward or backward direction. Therefore, an accelerating performance as well as a performance to propel the vehicle backwardly can be improved. In addition, the continuously variable transmission 1 is not involved in the torque transmission to launch the vehicle, therefore, the belt clamping pressure of the continuously variable transmission 1 does not have to be increased so that a power loss might be caused by increasing the clamping pressure can be reduced. In addition, durability of the continuously variable transmission 1 can be improved. Further, according to the power transmission unit of the present invention, the friction clutch or the dog clutch having a unified structure can be used as the clutch devices. Therefore, number of parts can be reduced to simplify the structure of the power transmission unit and to downsize the power transmission unit.

As described, according to the power transmission unit of the present invention, when transmitting torque from the input shaft 9 to the carrier 21 of the torque reversing device 16, the rotational speed is reduced by the gear train 23. That is, the speed difference among the rotary members of the torque reversing device 16 is reduced. Therefore, it is unnecessary to arrange an additional clutch for reducing such speed difference in the torque reversing device 16 which might be caused by transmitting the torque from the input shaft 9 to the output shaft 15 through the continuously variable transmission 1. For this reason, the structure of the power transmission unit can be simplified so that the power transmission unit can be downsized.

As also described, according to the power transmission unit shown in FIG. 1, the second clutch device C2 is disposed on the input shaft 9. Therefore, the torque is applied to the second clutch device C2 from the input shaft 9 without increasing or decreasing the rotational speed other than the torque converter 3 during running in the forward direction. That is, the torque greater than the torque of the input shaft 9 will not be applied to the second clutch device C2 during running. For this reason, a clutch whose torque capacity is smaller can be used as the second clutch device C2, in comparison with a case in which the second clutch device C2 is disposed on the output shaft 15 or the counter shaft 24 where a large torque might be applied thereto.

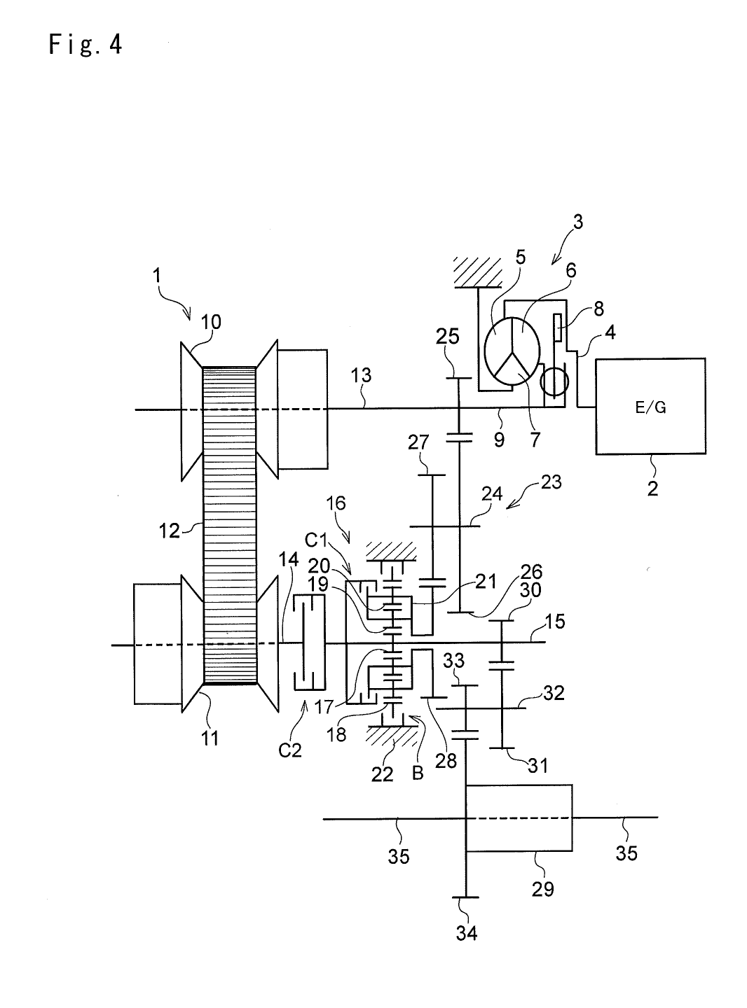

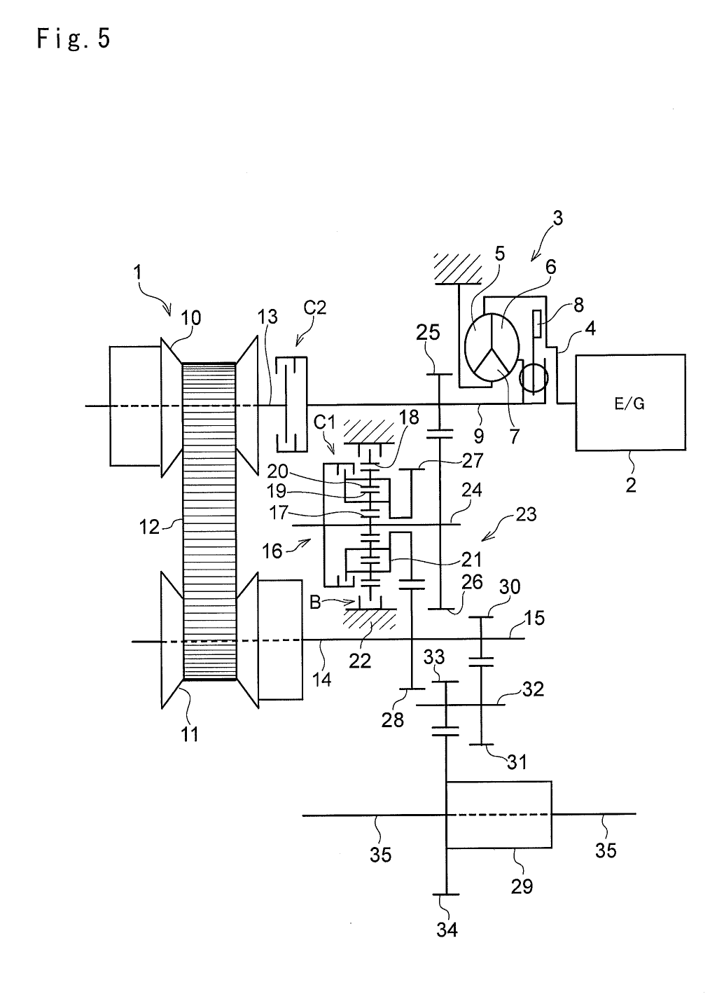

In the power transmission unit according to the present invention, in case of transmitting torque from the input shaft 9 to the output shaft 15 through the torque transmitting route having the gear train 23, the torque transmitting route having the continuously variable transmission 1 is disconnected from the input shaft 9 or the output shaft 15. By contrast, in case of transmitting torque from the input shaft 9 to the output shaft 15 through the torque transmitting route having the continuously variable transmission 1, the torque transmitting route having the gear train 23 is disconnected from the input shaft 9 or the output shaft 15. This means that the second clutch device C2 is not necessarily to be disposed at the site shown in FIG. 1. In other words, a position of the second clutch device C2 may be changed arbitrarily unless otherwise the power transmission unit loses function thereof. In addition, the torque reversing device 16 is also not necessarily to be disposed at the site shown in FIG. 1. For example, the torque reversing device 16 may also be arranged coaxially with the counter shaft 24 serving as the intermediate shaft 24, instead of the output shaft 15. Examples of such modifications will be explained hereinafter with reference to FIGS. 4 to 5.

In the power transmission unit shown in FIG. 4, the second clutch device C2 is also disposed on the output shaft 15 together with the torque reversing device 16, and remaining structures are similar to those of the example shown in FIG. 1. Therefore, common reference numerals are allotted to the common elements in FIG. 4, and detailed explanations for those common elements are omitted.

According to the present invention, the second clutch device C2 is used to selectively allow and enable torque transmission from the input shaft 9 to the output shaft 9 through the torque transmitting route having the continuously variable transmission 1. To this end, according to the example shown in FIG. 4, the second clutch device C2 is disposed on the output shaft 15 to selectively allow and enable torque transmission between the secondary shaft 14 of the continuously variable transmission 1 and the output shaft 15. As a result of such alteration form the example shown in FIG. 1, the input shaft 9 is connected directly to the primary shaft 13 of the continuously variable transmission 1.

According to the power transmission unit shown in FIG. 4, the first clutch device C1, the second clutch device C2 and the brake device B are engaged and disengaged in the same manner as shown in FIG. 3 to launch the vehicle in the forward direction, and to propel the vehicle in the forward and the backward directions. In addition, the torque transmission through the torque transmitting route having the gear train 23 and the torque reversing device 16, and the torque transmission through the torque transmitting route having the continuously variable transmission 1 are also performed in the same manner as the power transmission unit shown in FIG. 1. Accordingly, the same action and advantage as the power transmission unit shown in FIG. 1 can be achieved.

Specifically, according to the example shown in FIG. 4, the second clutch device C2 is disposed on the output side of the continuously variable transmission 1. Therefore, in case of decelerating the vehicle under the condition where the input shaft 9 is connected with the output shaft 15 through the gear train 23 and the torque reversing device 16, the continuously variable transmission 1 can be disconnected from the output shaft 15 by the second clutch device C2. Consequently, an excessive torque will not be applied to the continuously variable transmission 1 so that durability of the continuously variable transmission 1 can be improved. Specifically, given that the vehicle is decelerated while engaging the first clutch device C1, an inertia torque is applied to the output shaft 15. In this situation, the output shaft 15 is disconnected from the secondary shaft 14 of the continuously variable transmission 1 by disengaging the second clutch device C2. Therefore, so-called a “reverse torque” resulting from decelerating the vehicle will not be applied to the continuously variable transmission 1. That is, unnecessary torque will not be applied to the continuously variable transmission 1 so that the continuously variable transmission 1 can be prevented from being rotated unnecessary. For this reason, durability of the continuously variable transmission 1 can be improved.

In the power transmission unit shown in FIG. 5, the torque reversing device 16 is disposed on the counter shaft 24 serving as the intermediate shaft 24 of the gear train 23, and remaining structures are similar to those of the example shown in FIG. 1. Therefore, common reference numerals are allotted to the common elements in FIG. 5, and detailed explanations for those common elements are omitted.

As described, the torque reversing device 16 is adapted to shift between the forward stage and the reverse stage. To this end, the torque reversing device 16 may also be disposed on the counter shaft 24 instead of the output shaft 15. As the example shown in FIG. 1, the double-pinion planetary gear unit is used as the torque reversing device 16 also in the example shown in FIG. 5. Accordingly, the sun gear 17 is fitted onto the counter shaft 24 to be connected with the input shaft 9 through the drive gear 25 and the counter driven gear 26 of the gear train 23. That is, the sun gear 17 serves as the input element. In order to selectively stop the rotation of the ring gear 18, the brake device B is disposed between the ring gear 18 serving as a reaction element and a fixing portion 22. The carrier 21 is integrated with the counter drive gear 27 of the gear train 23 to be connected with the assembly of the secondary shaft 14 of the of the continuously variable transmission 1 and the output shaft 15 through the counter drive gear 27 and the driven gear 28 to serve as an output element. In order to connect the sun gear 17 with the carrier 21 thereby rotating the planetary gear unit integrally, the first clutch device C1 is disposed between the sun gear 17 and the carrier 21.

According to the example shown in FIG. 5, the counter driven gear 26 is diametrically larger than the drive gear 25 so that the rotational speed of the counter driven gear 26 is reduced when transmitting torque from the drive gear 25 to the counter driven gear 26. That is, the speed ratio (i.e., a gear ratio) of the gear train 23 of the case of transmitting torque from the drive gear 25 to the sun gear 17 of the torque reversing device 16 through the counter driven gear 26 serving as the first idle gear is larger than “1”, and this is larger than the maximum speed ratio of the continuously variable transmission 1.

According to the power transmission unit shown in FIG. 5, the first clutch device C1, the second clutch device C2 and the brake device B are engaged and disengaged in the same manner as shown in FIG. 3 to launch the vehicle in the forward direction, and to propel the vehicle in the forward and the backward directions. In addition, the torque transmission through the torque transmitting route having the gear train 23 and the torque reversing device 16, and the torque transmission through the torque transmitting route having the continuously variable transmission 1 are also performed in the same manner as the power transmission unit shown in FIG. 1. Accordingly, the same action and advantage as the power transmission unit shown in FIG. 1 can be achieved.

According to the power transmission unit shown in FIG. 5, as the power transmission unit shown in FIG. 1, the second clutch device C2 is also disposed on the input side of the continuously variable transmission 1. Therefore, the torque greater than the torque of the input shaft 9 will not be applied to the second clutch device C2 during propelling the vehicle by the power of the engine 2 in the forward direction. For this reason, the second clutch device C2 may also be downsized according to the example shown in FIG. 5.

In addition, when transmitting the torque from the input shaft 9 to the sun gear 17, that is, to the input element of the torque reversing device 16 in the example shown in FIG. 5, the rotational speed is reduced by the drive gear 25 and the counter driven gear 26 of the gear train 23. That is, the speed difference among the rotary members of the torque reversing device 16 is also reduced according to the example shown in FIG. 5. Therefore, it is unnecessary to arrange an additional clutch for reducing such speed difference in the torque reversing device 16 so that the power transmission unit can be downsized.

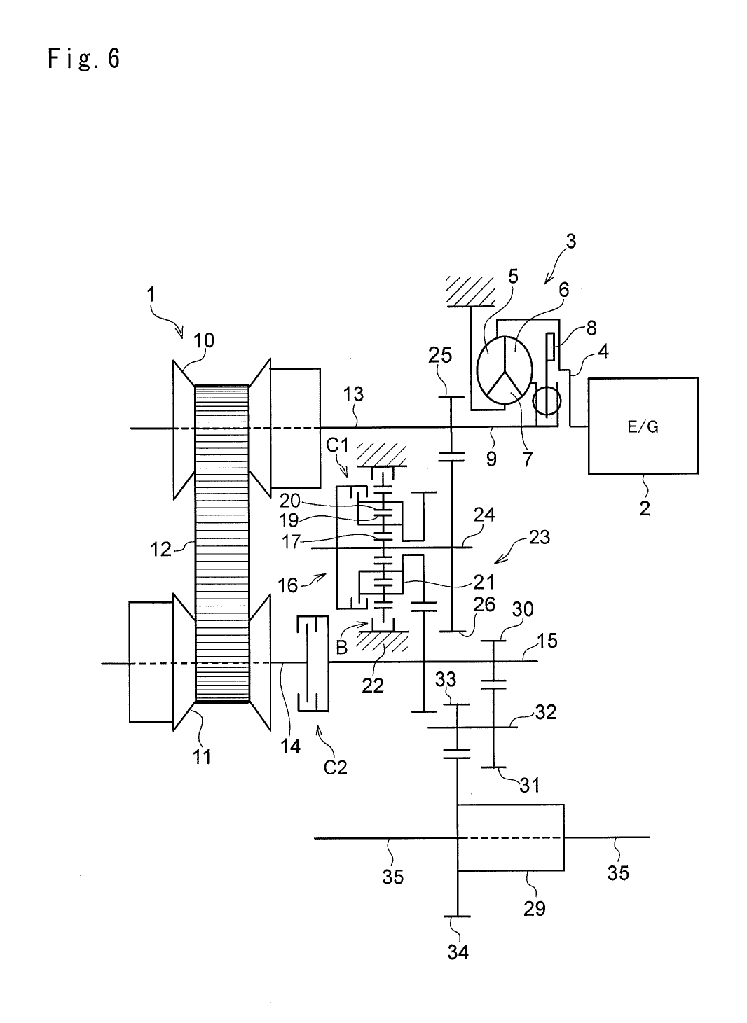

In the power transmission unit shown in FIG. 6, the second clutch device C2 is disposed on the output shaft 15, and remaining structures are similar to those of the example shown in FIG. 5. Therefore, common reference numerals are allotted to the common elements in FIG. 6, and detailed explanations for those common elements are omitted.

According to the example shown in FIG. 6, torque transmission between the secondary shaft 14 of the continuously variable transmission 1 and the output shaft 15 is selectively allowed and interrupted by the second clutch device C2 thus disposed on the output shaft 15. As a result of such alteration of the position of the second clutch device C2, the input shaft 9 is directly connected to the secondary shaft 14 of the continuously variable transmission 1.

According to the power transmission unit shown in FIG. 6, the first clutch device C1, the second clutch device C2 and the brake device B are engaged and disengaged in the same manner as shown in FIG. 3 to launch the vehicle in the forward direction, and to propel the vehicle in the forward and the backward directions. In addition, the torque transmission through the torque transmitting route having the gear train 23 and the torque reversing device 16, and the torque transmission through the torque transmitting route having the continuously variable transmission 1 are also performed in the same manner as the power transmission units shown in FIGS. 1 and 5. Accordingly, the same action and advantage as the power transmission units shown in FIGS. 1 and 5 may also be achieved.

According to the power transmission unit shown in FIG. 6, the second clutch device C2 is disposed on the output side of the continuously variable transmission 1. Therefore, in case of decelerating the vehicle under the condition where the input shaft 9 is connected with the output shaft 15 through the gear train 23 and the torque reversing device 16, the continuously variable transmission 1 can be disconnected from the output shaft 15 by the second clutch device C2. Consequently, an excessive torque will not be applied to the continuously variable transmission 1 so that durability of the continuously variable transmission 1 can be improved. Specifically, given that the vehicle is decelerated while engaging the first clutch device C1, an inertia torque is applied to the output shaft 15. In this situation, the output shaft 15 is disconnected from the secondary shaft 14 of the continuously variable transmission 1 by disengaging the second clutch device C2. Therefore, so-called a “reverse torque” resulting from decelerating the vehicle will not be applied to the continuously variable transmission 1. That is, unnecessary torque will not be applied to the continuously variable transmission 1 so that the continuously variable transmission 1 can be prevented from being rotated unnecessary. For this reason, durability of the continuously variable transmission 1 can be improved.

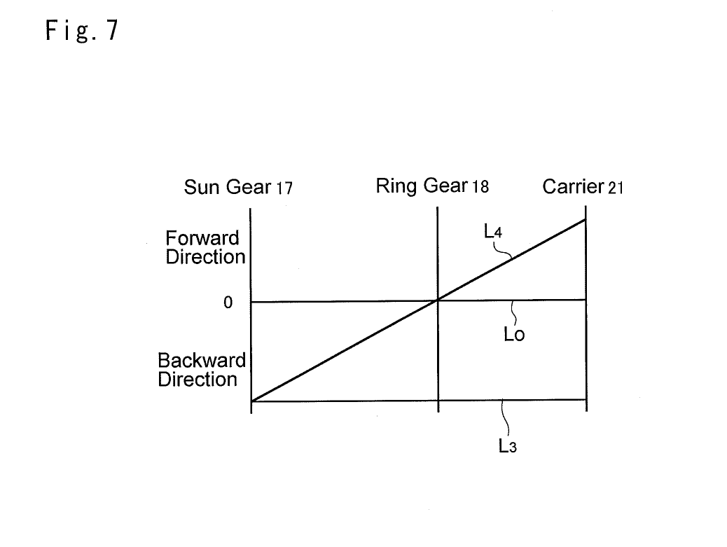

Referring now to FIG. 7, there is shown a nomographic diagram (or speed diagram) indicating the planetary gear unit serving as the torque reversing device 16 of the examples shown in FIGS. 5 and 6. In FIG. 7, as the nomographic diagram shown in FIG. 2, the vertical lines parallel to one another individually represent the sun gear 17, the ring gear 18, and the carrier 21. In FIG. 7, the distance between each vertical line and the intersection with a base line L0 also represents a rotational speed of the rotary element, and the vertical position with respect to the base line L0 also represents a rotational direction of the rotary element. As described, the torque reversing device 16 is rotated integrally by bringing the first clutch C1 into engagement. In this case, therefore, the rotational speeds of those rotary elements are indicated as a line L3. Given that the ring gear 18 is halted by the brake device B, the rotational speeds of those rotary elements are indicated as a line L4. That is, the carrier 21 is rotated in a direction opposite to the rotational direction of the sun gear 17. According to the planetary gear unit shown in FIG. 2, the carrier 21 serves as the input element to which the torque is applied in the same direction as the rotational direction of the crank shaft of the engine 2 (i.e., in the forward direction). By contrast, according to the planetary gear unit shown in FIG. 7, the sun gear 17 serves as the input element to which the torque is applied in the direction opposite to the rotational direction of the crank shaft of the engine 2 (i.e., in the backward direction).

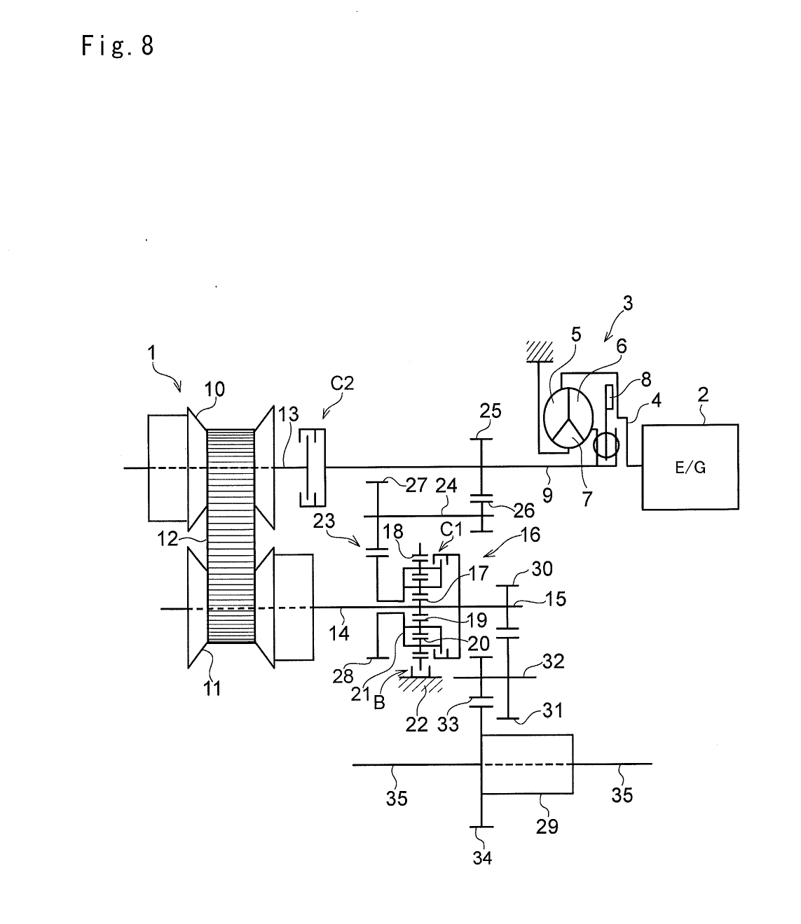

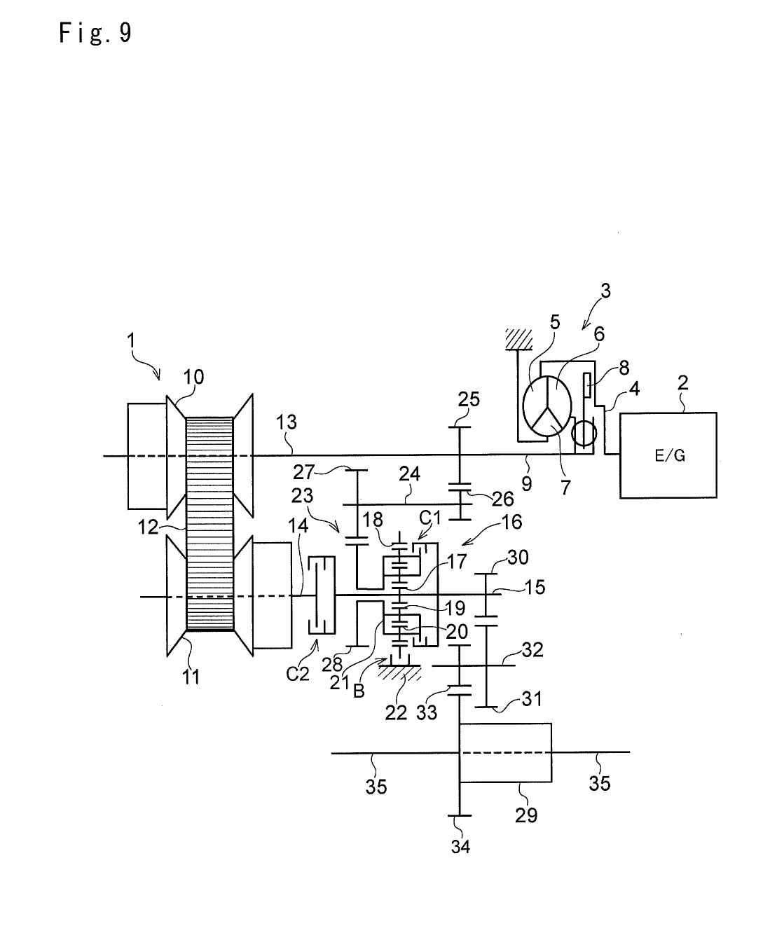

An orientation of the torque reversing device 16 of the power transmission unit may be altered as shown in FIGS. 8, 9, 10 and 11, instead of the positions shown in FIGS. 1, 4, 5 and 6. Specifically, the torque reversing device 16 shown in FIGS. 1 and 4 may also be disposed on the output shaft 15 while reversing orientation as shown in FIGS. 8 and 9. In this case, the torque reversing device 16 is disposed on the output shaft 15 in a manner such that the first clutch device C1 is situated on the side close to the engine 2 (i.e., on the right side in FIGS. 8 and 9), and that the connection between the carrier 21 and the driven gear 28 is situated on the side close to the continuously variable transmission 1 (i.e., on the left side in FIGS. 8 and 9).

According to the power transmission units shown in FIGS. 8 and 9, the first clutch device C1, the second clutch device C2 and the brake device B are engaged and disengaged in the same manner as shown in FIG. 3 to launch the vehicle in the forward direction, and to propel the vehicle in the forward and the backward directions. Accordingly, the same action and advantage as the power transmission unit shown in FIG. 1 may also be achieved.

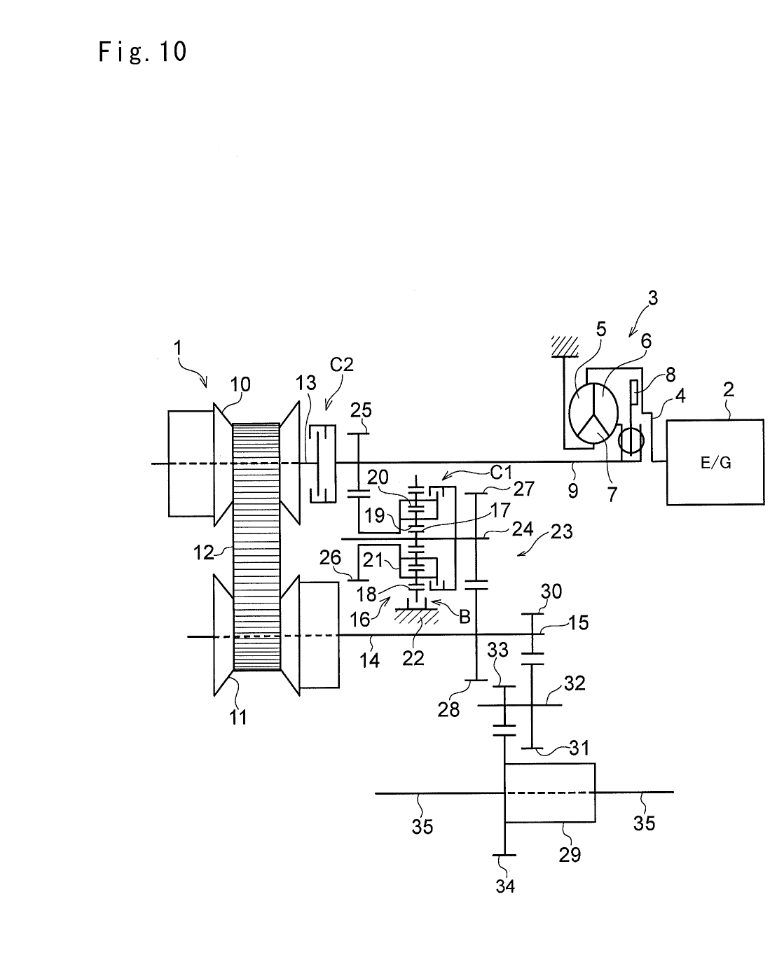

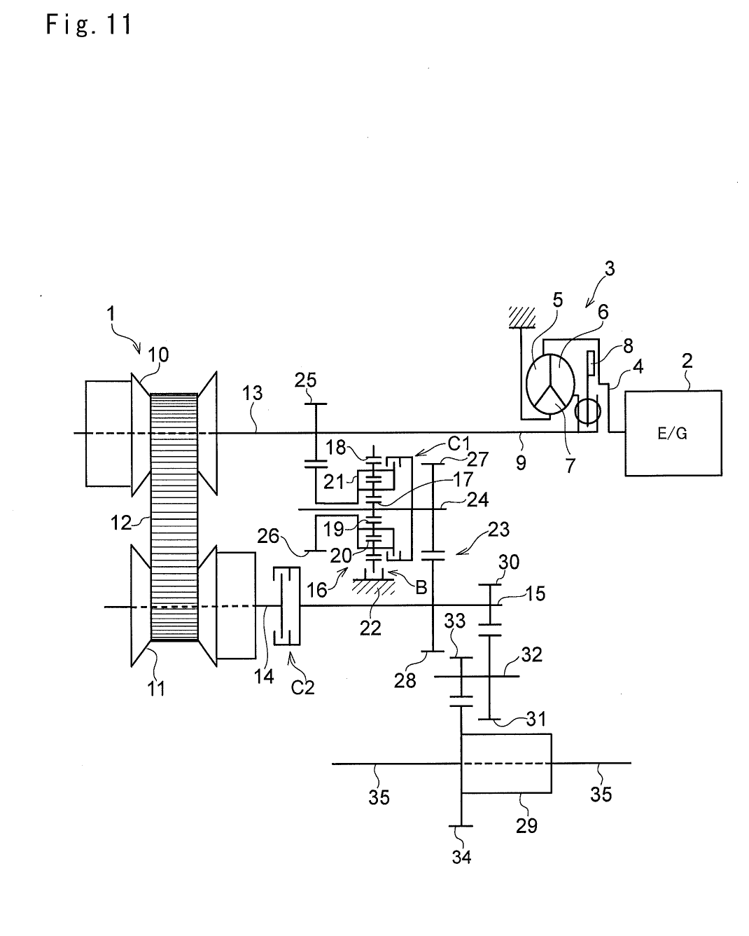

The torque reversing device 16 shown in FIGS. 5 and 6 may also be disposed on the counter shaft 24 while reversing orientation and switching the input element and the output element as shown in FIGS. 10 and 11. Specifically, the torque reversing device 16 is disposed on the counter shaft 24 in a manner such that the first clutch device C1 is situated on the side close to the engine 2 (i.e., on the right side in FIGS. 10 and 11), and that the connection between the carrier 21 and the driven gear 28 is situated on the side close to the continuously variable transmission 1 (i.e., on the left side in FIGS. 10 and 11). In this case, the carrier 21 is connected to the counter driven gear 26 to serve as the input element, and the sun gear 17 is fitted onto the counter shaft 24 to serve as the output element.

According to the power transmission units shown in FIGS. 10 and 11, the first clutch device C1, the second clutch device C2 and the brake device B are engaged and disengaged in the same manner as shown in FIG. 3 to launch the vehicle in the forward direction, and to propel the vehicle in the forward and the backward directions. Accordingly, the same action and advantage as the power transmission unit shown in FIG. 1 may also be achieved.

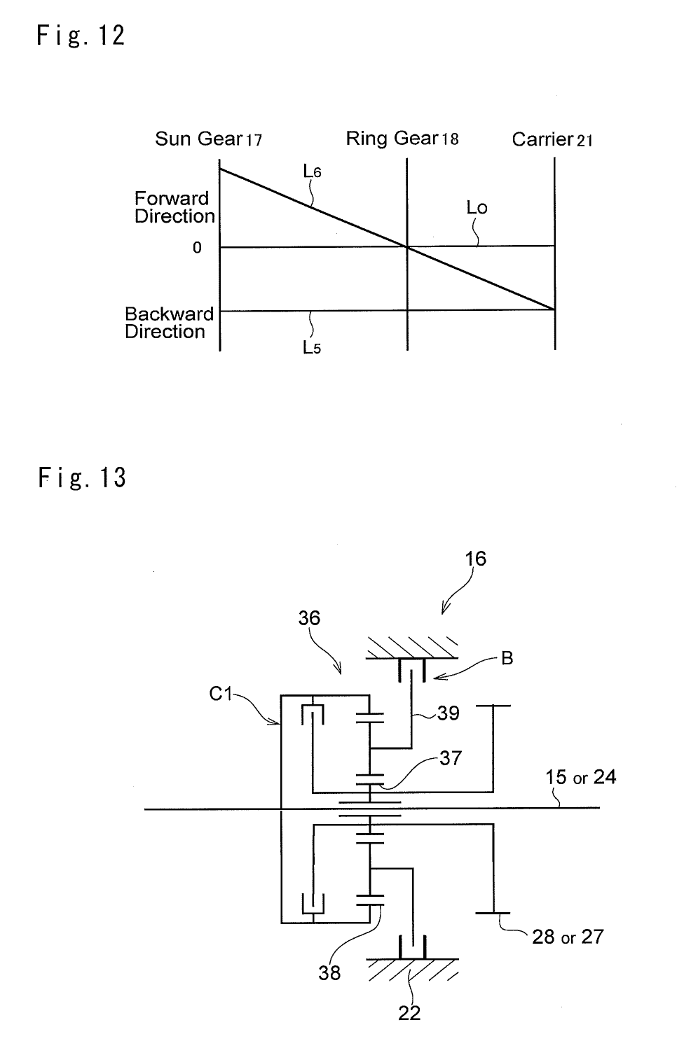

Referring now to FIG. 12, there is shown a nomographic diagram (or speed diagram) indicating the planetary gear unit serving as the torque reversing device 16 of the examples shown in FIGS. 10 and 11. In FIG. 12, as the nomographic diagram shown in FIG. 7, the vertical lines parallel to one another individually represent the sun gear 17, the ring gear 18, and the carrier 21. In FIG. 12, the distance between each vertical line and the intersection with a base line L0 also represents a rotational speed of the rotary element, and the vertical position with respect to the base line L0 also represents a rotational direction of the rotary element. As described, the torque reversing device 16 is rotated integrally by bringing the first clutch C1 into engagement. In this case, therefore, the rotational speeds of those rotary elements are indicated as a line L5. Given that the ring gear 18 is halted by the brake device B, the rotational speeds of those rotary elements are indicated as a line L6. That is, the sun gear 17 is rotated in a direction opposite to the rotational direction of the carrier 21. According to the planetary gear unit shown in FIG. 7, the sun gear 17 serves as the input element to which the torque is applied in the direction opposite to the rotational direction of the crank shaft of the engine 2 (i.e., in the reverse direction). By contrast, according to the planetary gear unit shown in FIG. 12, the carrier 21 serves as the input element to which the torque is applied in the direction opposite to the rotational direction of the crank shaft of the engine 2 (i.e., in the backward direction).

In the power transmission unit of the present invention, a single-pinion planetary gear unit may also be used as the torque reversing device 16 instead of the double-pinion planetary gear unit. An example of using the single-pinion planetary gear unit as the torque reversing device 16 in the examples shown in FIGS. 1, 4, 5 and 6 is shown in FIG. 13. In case of using the single-pinion planetary gear unit 36 as the torque reversing device 16, a sun gear 37 serves as the input element, a ring gear 38 serves as the reaction element, and the carrier 39 serves as the output element. In order to selectively halt rotation of the carrier 39, the brake device B is disposed on the casing. The sun gear 37 is connected to the driven gear 28 of the gear train 23, and the ring gear 38 is connected to the output shaft 15. In order to selectively connect the sun gear 37 with the ring gear 38, the first clutch device C1 is disposed between the sun gear 37 and the ring gear 38.

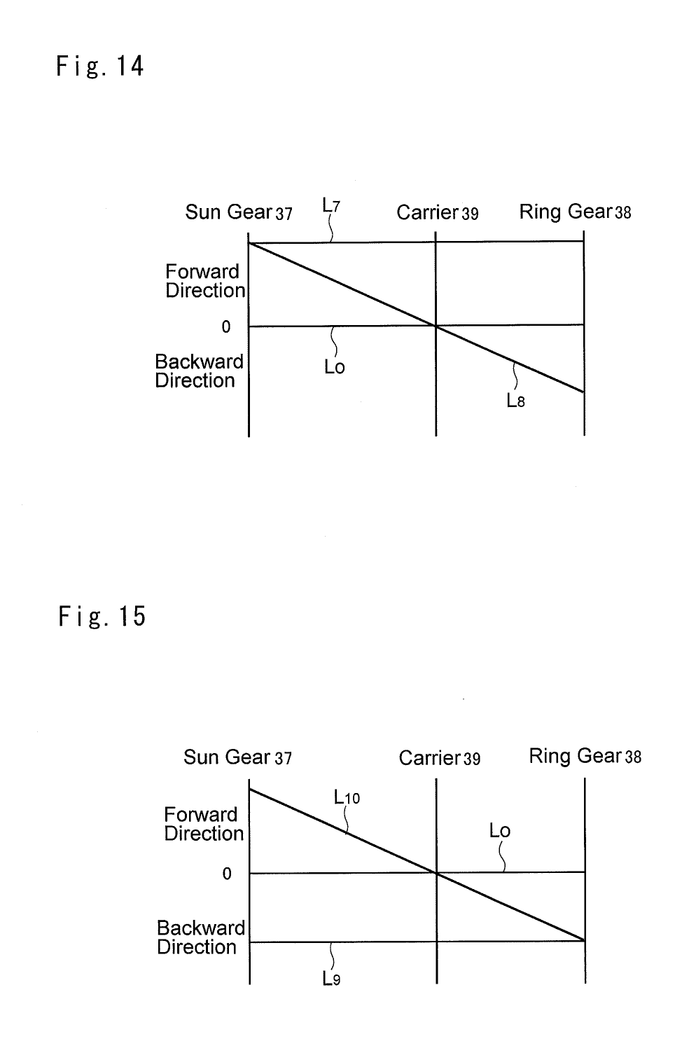

Referring now to FIG. 14, there is shown a nomographic diagram (or speed diagram) indicating the single-pinion planetary gear unit 36 serving as the torque reversing device 16 of the examples shown in FIGS. 1 and 4. In FIG. 14, the vertical lines parallel to one another individually represent the sun gear 37, the carrier 39, and the ring gear 38. Specifically, the line representing the sun gear 37 is situated in the left side, the line representing the ring gear 38 is situated in the right side, and the line representing the carrier 39 as the reaction element is situated in the middle. Given that an interval between the line representing the sun gear 37 and the line representing the ring gear 38 is set to “1”, an interval between the line representing the carrier 39 and the line representing the ring gear 38 is set to a value corresponding to a ratio between tooth number of the sun gear 37 and tooth number of the carrier 39 (i.e., a gear ratio). In FIG. 14, a distance between each vertical line and an intersection with a base line L0 represents a rotational speed of the rotary element, and a vertical position with respect to the base line L0 represents a rotational direction of the rotary element. The planetary gear unit 36 serving as the torque reversing device 16 is also rotated integrally by bringing the first clutch C1 into engagement. In this case, therefore, the rotational speeds of those rotary elements are indicated as a line L7. Given that the carrier 39 is halted by the brake device B, the rotational speeds and directions of those rotary elements are indicated as a line L8. That is, the ring gear 38 is rotated in a direction opposite to the rotational direction of the sun gear 37.

In case of thus using the single-pinion planetary gear unit 36 as the torque reversing device 16 in the example shown in FIGS. 5 and 6, the ring gear 38 serves as the input element, the sun gear 37 serves as the reaction element, and the carrier 39 serves as the output element. In this case, the ring gear 38 is connected with the counter shaft 24 of the gear train 23, and the sun gear 37 is connected with the counter drive gear 27 of the gear train 23.

Referring now to FIG. 15, there is shown a nomographic diagram (or speed diagram) indicating the single-pinion planetary gear unit 36 serving as the torque reversing device 16 of the examples shown in FIGS. 5 and 6. In FIG. 15, the vertical lines parallel to one another individually represent the sun gear 37, the carrier 39, and the ring gear 38. In FIG. 15, as the nomographic diagram shown in FIG. 14, a distance between each vertical line and an intersection with a base line LO represents a rotational speed of the rotary element, and a vertical position with respect to the base line L0 represents a rotational direction of the rotary element. The planetary gear unit 36 serving as the torque reversing device 16 is also rotated integrally by bringing the first clutch C1 into engagement. In this case, therefore, the rotational speeds of those rotary elements are indicated as a line L9. Given that the carrier 39 is halted by the brake device B, the rotational speeds and directions of those rotary elements are indicated as a line L10. That is, the ring gear 38 is rotated in a direction opposite to the rotational direction of the sun gear 37. According to the planetary gear unit 36 shown in FIG. 14, the sun gear 37 serves as the input element to which the torque is applied in the same direction as the rotational direction of the crank shaft of the engine 2 (i.e., in the forward direction). By contrast, according to the planetary gear unit 36 shown in FIG. 15, the ring gear 38 serves as the input element to which the torque is applied in the direction opposite to the rotational direction of the crank shaft of the engine 2 (i.e., in the backward direction).

Thus, the single-pinion planetary gear unit 36 may also be used as the torque reversing device 16 instead of the double-pinion planetary gear unit. In addition, structure of the power transmission unit can be simplified by thus employing the single-pinion planetary gear unit 36 instead of the double-pinion planetary gear unit.

As described, the torque reversing device 16 is rotated integrally by connecting at least two rotary elements thereof by the first clutch device C1 so that the gear train 23 is enabled to transmit power between the input shaft 9 and the output shaft 15 through the torque reversing device 16. In this situation, the continuously variable transmission 1 is disconnected form the output shaft 15, and the gear train 23 is connected with the output shaft 15 by disengaging the second clutch device C2. That is, the input shaft 9 is connected with the output shaft 15 through the gear train 23 and the torque reversing device 16. Consequently, a speed ratio that cannot be established by the continuously variable transmission 1 is achieved by the gear train 23. Specifically, the speed ratio larger than the maximum speed ratio of the continuously variable transmission 1 or smaller than the minimum speed ratio of the continuously variable transmission 1 is established by the gear train 23. Thus, a range of a total speed ratio of the power transmission unit can be widened wider than that of the continuously variable transmission 1.

In addition, rotation of the reaction element of the torque reversing device 16 can be halted by engaging the brake device B instead of the first clutch device C1. Consequently, the output element of the torque reversing device 16 is rotated in the direction opposite to the input element, that is, the vehicle is propelled in the backward direction. In this situation, the torque is transmitted from the output element of the torque reversing device 16 to the output shaft 15 through the gear train 23 and the torque reversing device 16. As a result, the power transmission unit is allowed to establish the speed ratio which cannot be achieved by the continuously variable transmission 1. In addition, the speed ratio of the power transmission unit can be widened also in case of propelling the vehicle in the backward direction.

The axial positions of the first clutch device C1, the second clutch device C2 and the above-explained gears may be altered according to a design requirement. For example, in the foregoing examples, positions of the elements adjacent to each other may be switched in the axial direction.

In addition, in the foregoing examples, the gear train 23 is adapted to establish on speed ratio (i.e., a gear ratio), however, the gear train may also be adapted to selectively establish more than two kinds of speed ratios.

1. A power transmission unit for a vehicle, comprising:
a continuously variable transmission that is adapted to alter a speed ratio continuously, and that is disposed between an input shaft to which a torque of a prime mover is inputted and an output shaft that outputs the torque;
a gear train that has an intermediate shaft arranged at a different site from positions of the input shaft and the output shaft, and that is adapted to establish a speed ratio that cannot be established by the continuously variable transmission;
wherein the torque is transmitted between the input shaft and the output shaft through the continuously variable transmission and the gear train;
a torque reversing device that is adapted to perform a differential action among an input element, an output element and a reaction element adapted to rotate the input element and the output element in opposite directions when rotation thereof is halted, and that is disposed coaxially with the output shaft or the intermediate shaft;
a first clutch device that connects at least any of two rotary elements of the torque reversing device; and
a brake device that halts rotation of the reaction element;
wherein the input shaft is connected with the output shaft through the continuously variable transmission, and a second clutch device is disposed on a torque transmitting route from the input shaft to the output shaft via the continuously variable transmission to allow and interrupt torque transmission therethrough; and
wherein the input shaft is connected with the output shaft through the gear train and the torque reversing device.

2. The power transmission unit for a vehicle as claimed in claim 1, wherein the gear train is adapted to establish a speed ratio larger than a maximum speed ratio of the continuously variable transmission or a speed ratio smaller than a minimum speed ratio of the continuously variable transmission using a plurality of gears.

3. The power transmission unit for a vehicle as claimed in claim 1,
wherein the continuously variable transmission is comprised of a drive member to which the torque is transmitted from the input shaft, and an output member that outputs the torque to the output shaft; and
wherein the second clutch device is disposed between the input shaft and the drive member to selectively connect the input shaft to the drive member.

4. The power transmission unit for a vehicle as claimed in claim 1,
wherein the continuously variable transmission is comprised of a drive member to which the torque is transmitted from the input shaft, and an output member that outputs the torque to the output shaft; and
wherein the second clutch device is disposed between the output member and the output shaft to selectively connect the output shaft to the output shaft.

5. The power transmission unit for a vehicle as claimed in claim 1, wherein each of the first clutch device and the second clutch device is individually formed by a fiction clutch.

6. The power transmission unit for a vehicle as claimed claim 1,
wherein the gear train is comprised of
a drive gear disposed coaxially with the input shaft,
an idle gear disposed on the intermediate shaft or plurality of idle gears rotated integrally, and
a driven gear to which the torque is transmitted from the drive gear through the idle gear, and that is connected to the input element; and
wherein the gear train is adapted to establish a speed ratio larger than 1 in case of transmitting the torque from the drive gear to the input element through the idle gear and the driven gear.

7. The power transmission unit for a vehicle as claimed claim 1,
wherein the gear train is comprised of
a drive gear disposed coaxially with the input shaft,
a driven gear disposed coaxially with the output shaft,
a first idle gear disposed coaxially with the intermediate shaft to transmit the torque between the drive gear and the input element, and
a second idle gear disposed coaxially with the intermediate shaft to transmit the torque between the output element and the drive gear; and
wherein the gear train is adapted to establish a speed ratio larger than 1 at least in any of
a case of transmitting the torque from the drive gear to the input element through the first idle gear, and
a case of transmitting the torque from the driven gear to the output element through the second idle gear.

8. The power transmission unit for a vehicle as claimed claim 1, wherein the torque reversing device includes a double-pinion planetary gear unit comprising:
a sun gear as an external gear;
a ring gear as an internal gear arranged concentrically with the sun gear;
a first pinion gear meshing with the sun gear;
a second pinion gear meshing with the first pinion gear and the ring gear; and
a carrier supporting the first pinion gear and the second pinion gear while allowing to rotate and revolve.

9. The power transmission unit for a vehicle as claimed in claim 8,
wherein the sun gear is connected to the continuously variable transmission and the output shaft;
wherein the carrier is connected to the gear train; and
wherein rotation of the ring gear is halted by the brake device.

10. The power transmission unit for a vehicle as claimed in claim 8,
wherein the sun gear is connected to the intermediate shaft and the first idle gear;
wherein the carrier is connected to the second idle gear; and
wherein rotation of the ring gear is halted by the brake device.

11. The power transmission unit for a vehicle as claimed in claim 8,
wherein the sun gear is connected to the intermediate shaft and the second idle gear;
wherein the carrier is connected to the first idle gear; and
wherein rotation of the ring gear is halted by the brake device.

12. The power transmission unit for a vehicle as claimed claim 1, wherein the torque reversing device includes a single-pinion planetary gear unit comprising:
a sun gear as an external gear;
a ring gear as an internal gear arranged concentrically with the sun gear;
a pinion gear meshing with the sun gear and the ring gear; and
a carrier supporting the pinion gear while allowing to rotate and revolve.

13. The power transmission unit for a vehicle as claimed in claim 12,
wherein the ring gear is connected to the continuously variable transmission and the output shaft;
wherein the sun gear is connected to the gear train; and
wherein rotation of the carrier is halted by the brake device.

14. The power transmission unit for a vehicle as claimed in claim 12,
wherein the ring gear is connected to the intermediate shaft and the first idle gear;
wherein the sun gear is connected to the second idle gear; and
wherein rotation of the carrier is halted by the brake device.

15. The power transmission unit for a vehicle as claimed in claim 12,
wherein the ring gear is connected to the intermediate shaft and the second idle gear;
wherein the sun gear is connected to the first idle gear; and
wherein rotation of the carrier is halted by the brake device.

16. The power transmission unit for a vehicle as claimed claim 1,
wherein the torque reversing device includes a planetary gear unit in which the input element, the output element and the reaction element are indicated in a nomographic diagram by lines parallel to one another, and in which rotational speeds of those rotary elements are indicated individually by a distance between each line and an intersection with a base line and a position with respect to the base line; and
wherein the reaction element is represented by the line situated in the middle of those lines in the nomographic diagram, the input element is represented by the line situated in any of right and left sides of the nomographic diagram, and the reaction element is represented by the line situated on the other side of the nomographic diagram.
